(19) United States
(12) Patent Application Publication
(10) Pub. No.: US 2015/0357845 A1
(43) Pub. Date: Dec. 10, 2015

(54) BATTERY MANAGEMENT SYSTEM FOR A WATERCRAFT MOTOR MODULE

(71) Applicant: BOOMERBOARD, LLC, Branford, CT (US)

(72) Inventor: Mike R. Railey, Del Mar, CA (US)

(73) Assignee: Boomerboard, LLC, Branford, CT (US)

(21) Appl. No.: 14/763,305

(22) PCT Filed: Jan. 24, 2014
(86) PCT No.: PCT/US2014/013044

§ 371 Date: Jul. 24, 2015

Related U.S. Application Data
(60) Provisional application No. 61/777,479, filed on Mar. 12, 2013.
(60) Provisional application No. 61/757,013, filed on Jan. 25, 2013.

(51) Int. Cl. H02J 7/00

(52) U.S. Cl. CPC H02J 7/0029; H02J 7/007; H02J 7/0021

(57) ABSTRACT

Disclosed herein is a battery management system. A housing may contain one or more of an electric motor, a battery electrically coupled to the electric motor, and a sensor configured to detect a harmful environmental condition within the housing. Such sensors can detect a potentially harmful condition including but not limited to smoke, heat, water, or shock. A circuit may be coupled to the at least one sensor and configured to uncouple the battery from the motor and discharge the battery when the sensor detects the harmful environmental condition. If a potential problem with the internal environment of the cassette is detected, the cassette batteries can be effectively disconnected with the main output, thus disabling the motors. Furthermore, energy stored in the batteries can be slowly and safely discharged. In some embodiments, when a potential problem with the internal environment of the cassette is detected, the batteries can be discharged and permanently disabled. Illustrative embodiments disclose a battery management system implemented in a motorized watercraft.

### CROSS-REFERENCE TO RELATED APPLICATIONS

This application claims the benefit of U.S. Provisional Application No. 61/757,013 filed on Jan. 25, 2013, entitled “BATTERY MANAGEMENT SYSTEM FOR WATERCRAFT MOTOR MODULE,” and U.S. Provisional Application No. 61/777,479 filed on Mar. 12, 2013, entitled “BATTERY MANAGEMENT SYSTEM FOR WATERCRAFT MOTOR MODULE,” both of which are hereby incorporated by reference in their entireties.

### BACKGROUND

1. Field

The present invention relates to a battery management and/or protection system. Some implementations disclosed herein are devices, systems, and methods for managing a battery used to power a motorized cassette. The motorized cassette may be used to propel watercraft such as surfboards.

2. Description of the Related Art

Lithium-ion batteries are common in consumer electronics and electric vehicles. Failure of lithium-ion batteries may lead to fire or explosion. Battery protection circuits are known that may be configured to prevent the formation of high currents and/or prevent overcharging. However, such known circuits do not take into account all relevant fault conditions.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of the system and methods provide several advantages over traditional systems and methods.

The subject matter disclosed herein relates to a battery protection system. The system may comprise one or more batteries, one or more sensors configured to detect at least one environmental condition external to the battery, and a circuit coupled to the one or more sensors. The circuit may be configured to discharge the one or more batteries based at least in part on sensor detection of the at least one environmental condition external to the battery.

In some embodiments, the circuit is configured to activate a display that is visible to a user based at least in part on sensor detection of the at least one environmental condition. The one or more batteries, the one or more sensors, and the circuit may be housed within an enclosure. A measurement interface may be disposed outside of the enclosure and coupled to the one or more batteries for measuring electrical battery parameters. In some aspects, the at least one environmental condition is an environmental condition that is not caused by the one or more batteries. At least one sensor may be configured to detect water. At least one sensor may be configured to detect water using adjacent traces on a printed circuit board that are conductively connected in the presence of water. At least one sensor may be configured to detect mechanical shock. At least one sensor may be configured to detect smoke. At least one sensor may be configured to detect temperature. At least one sensor may be configured to detect mechanical stress. In some embodiments, at least two sensors are configured to detect two or more of water, smoke, temperature, mechanical stress, and mechanical shock. Multiple sensors may be disposed in various positions within an enclosure.

In some embodiments, a cassette for propelling a personal watercraft comprises a housing containing at least one electric motor, one or more batteries electrically coupled to the at least one electric motor, and one or more sensors configured to detect at least one environmental condition external to the one or more batteries, and a circuit coupled to the one or more sensors. The circuit may be configured to discharge the one or more batteries based at least in part on sensor detection of the at least one environmental condition.

In some embodiments, a personal watercraft comprises a body, at least one electric motor, one or more batteries coupled to the at least one electric motor, one or more impellers coupled to the at least one electric motor, at least one sensor configured to monitor one or both of at least one electrical condition of the one or more batteries and at least one environmental condition external to the one or more batteries, and a display configured to display information related to one or both of the at least one electrical condition of the one or more batteries the at least one environmental condition external to the one or more batteries to a user of the watercraft. The electrical condition may be a charge level of the battery. A circuit may be coupled to the at least one sensor and configured to discharge the battery when the circuit is activated. A user interface may be coupled to the circuit. The user interface may be configured to activate the circuit. The user interface may be wirelessly coupled to the circuit.

In some embodiments, a personal watercraft comprises a body, at least one electric motor, one or more batteries coupled to the at least one electric motor, one or more impellers coupled to the at least one electric motor, one or more sensors configured to detect at least one environmental condition external to the battery, and a circuit coupled to the one or more sensors configured to discharge the one or more batteries based at least in part on sensor detection of the at least one environmental condition external to the battery. The circuit may be configured to activate a display that is visible to a user based at least in part on sensor detection of the at least one environmental condition. The one or more batteries, the one or more sensors, and/or the circuit may be housed within an enclosure. A measurement interface may be disposed outside of the enclosure and coupled to the one or more batteries for measuring electrical battery parameters. The at least one environmental condition may be an environmental condition not caused by the one or more batteries.

In some embodiments a battery protection method comprises detecting at least one environmental condition external to a battery, and discharging the battery based at least in part on detection of the at least one environmental condition external to the battery. The method may include detecting an environmental condition that is not caused by the battery. The method may include one or more of detecting water, mechanical shock, smoke, temperature, and/or mechanical stress. The method may include detecting two or more of water, smoke, temperature, mechanical stress, and/or mechanical shock.

### BRIEF DESCRIPTION OF THE DRAWINGS

The following is a brief description of each of the drawings. From figure to figure, the same reference numerals have been used to designate the same components of an illustrated embodiment. The drawings disclose illustrative embodiments and particularly illustrative implementations in the context of motorized vehicles such as watercraft. They do not set forth all embodiments. Other embodiments may be used in addition to or instead. Conversely, some embodiments may be practiced without all of the details that are disclosed.

FIG. 1 is a perspective view of a personal watercraft including one embodiment of a motorized cassette received in a bottom recess of a surfboard.

FIG. 2 is an exploded view of the motorized cassette received in the bottom recess of the surfboard of FIG. 1.

FIG. 3 is a perspective view of the surfboard FIGS. 1 and 2 including a non-motorized cassette received in the bottom recess.

FIG. 4 is an exploded view of the surfboard of FIG. 3.

FIG. 5 is a perspective view of a surfboard including a second embodiment of a motorized cassette received in a bottom recess of the surfboard.

FIG. 6 is an exploded view of the surfboard of FIG. 5.

FIG. 7 is an exploded view of the motorized cassette of FIGS. 5 and 6.

FIG. 8 is a perspective cutaway view of the motorized cassette of

FIG. 9 is a block diagram of a battery management system for a motorized cassette according to one embodiment.

FIG. 10 is a top view of a motorized cassette having a user interface for a battery management system according to one embodiment.

FIG. 10A is an enlarged view of the user interface shown in FIG. 10.

FIG. 11 illustrates sample displays that may be displayed by the user interface for a battery management system shown in FIG. 10.

FIG. 12 is a perspective view of a wireless wrist controller that may be used the user interface for a battery management system shown in FIG. 10.

FIG. 13 is a top view of the wireless wrist controller shown in FIG. 12.

FIG. 14 is a top view of a motorized cassette having a user interface for a battery management system according to according to one embodiment.

FIGS. 15-16 are schematic wiring diagrams for a motorized cassette having a battery management system according to according to certain embodiments

### DETAILED DESCRIPTION

While the present disclosure relates primarily to battery safety in the context of a motorized cassette for use in a personal watercraft such as a surfboard, the inventions described herein can be implemented in a variety of applications. The battery condition of any device including a lithium and/or lithium ion battery may be monitored and discharged if unsafe conditions are detected. For example, battery conditions of personal electronics, such as, for example, laptops and tablets may be monitored using the techniques described herein. In general, disclosed herein are systems and methods that can detect the environmental conditions that a battery resides in. Batteries may be housed in hermitically sealed enclosures and/or not easily observed by a user. The system may monitor environmental conditions in and around the battery and may display the conditions to a user. In some embodiments, the system includes a sensor configured to detect water and/or moisture in and around the vicinity of a battery. Such an unsafe condition may be displayed to a user. In some embodiments, when an unsafe environmental condition is detected, a circuit can disconnect the battery output and/or input. In some embodiment, the circuit may trigger battery discharge.

Particular implementations of the subject matter described in this disclosure can be implemented to realize one or more of the following potential advantages. The embodiments described herein provide a device having a long battery life and that can be stored, shipped, or traveled with in a manner that is safe and compliant with government regulations. Shipping and carriage of lithium and/or lithium ion batteries is often regulated and/or restricted because of the possible risk of overheating, fire, rupture, and/or explosion. Damaged and/or compromised batteries and/or unsafe battery environments carry a risk of exploding when charging and/or discharging. Accordingly, the devices, systems, and methods disclosed herein provide one or more safety features.

In some advantageous embodiments, a motorized drive system is provided as a separately housed cassette. The cassette may house batteries, motors, control electronics, impellers, and associated drive hardware. This design has many significant advantages. It may be made removable and/or exchangeable. The cassette may also be used in a variety of watercraft, not just in surfboards.

The cassettes disclosed herein house, among other things, rechargeable batteries within a hermetically sealed enclosure. In some embodiments, the cassette is waterproof, meaning that the cassette is capable of being completely submerged under water for a substantial period of time without water penetrating the enclosure. The cassettes disclosed herein can include one or more sensors configured to detect a potential problem with the internal environment of the cassette or other sealed container in which such a battery is housed. Such sensors can detect a potentially harmful environmental condition including but not limited to smoke, heat, water, or shock. If a potential problem with the internal environment of the cassette is detected, the batteries can be effectively disconnected with the main output, thus disabling the motors. Furthermore, energy stored in the batteries can be slowly and safely discharged.

In some embodiments, when a potential problem with the internal environment of the cassette is detected, the batteries are discharged and may be permanently disabled. For example, in some embodiments, the housing includes a sensor configured to detect heat. When the heat sensor detects an unsafe temperature within the housing, the one or more batteries within the housing are effectively disconnected from the electric motors and batteries are slowly discharged. Similarly in some embodiments, the housing includes a sensor configured to detect moisture. When the moisture sensor detects an unsafe humidity level within the housing, the one or more batteries within the housing are effectively disconnected from the electric motors and batteries are slowly discharged.

In some embodiments, one or more sensors disposed within the sealed enclosure are configured to monitor one or more characteristics of each battery disposed within the sealed enclosure. In some embodiments, the physical battery size may be monitored. Increase in the physical battery size (i.e. battery swelling) may be an indication of a dangerous battery condition. As such, when a change in battery size is detected, the battery can be disabled and discharged. In some embodiments, the voltage, current, balance, internal impedance, discharge rate, temperature, and/or number of charge/discharge cycles of each battery is monitored. Such battery characteristics may be compared to normal operating parameters and the battery may be disabled and discharged when one or more characteristics are determined to be dangerous and/or abnormal. In some embodiments, the system is configured to inform the user and/or disable the cassette when the number of charge/discharge cycles has reached a pre-determined number. The user may then be instructed to return the cassette for inspection and/or maintenance. In some embodiments, one or more sensors are disposed on one or more batteries disposed within the cassette and configured to monitor the battery temperature. When a temperature outside of the normal operating range for the battery is detected, the battery can be disabled and discharged.

As used herein, the term “environmental condition external to the battery” means a physical condition measurable outside of the battery itself that is separate from electrical battery parameters such as output current, charging current, and output voltage. Conventional battery protection circuits focus on battery electrical parameters, but not on environmental conditions external to the battery as disclosed herein. Such environmental conditions can cause unsafe battery malfunctions that are not adequately addressed in conventional systems that focus on measuring battery electrical parameters.

Some important forms of these environmental conditions are not caused by the batteries themselves. For example, water-proof enclosures containing batteries may fail and leak, causing water to enter the enclosure and posing dangerous conditions for a battery inside. Dropping a battery powered system may result in dangerous battery malfunction from the mechanical shock. Other environmental conditions external to the battery may be caused by the batteries themselves, such as an increased temperature on or adjacent to the battery, or the presence of smoke. Another example is battery swelling, which may cause measurable changes in battery dimension or measurable stress on a battery mounting system.

In some implementations disclosed herein, a personal watercraft (which may include a motorized cassette) includes a user interface and a battery management system. The user interface can display battery charge levels. The user interface and battery management can also allow for a user to discharge the batteries such that the motorized cassette can be safely stored, shipped, or traveled with on an airplane. The user interface may inform the user of the battery condition within the housing.

These, as well as, other various aspects, components, steps, features, objects benefits, and advantages will now be described with reference to specific forms or embodiments selected for the purposes of illustration. It will be appreciated that the spirit and scope of the cassettes disclosed herein is not limited to the selected forms. Moreover, it is to be noted that the figures provided herein are not drawn to any particular proportion or scale, and that many variations can be made to the illustrated embodiments.

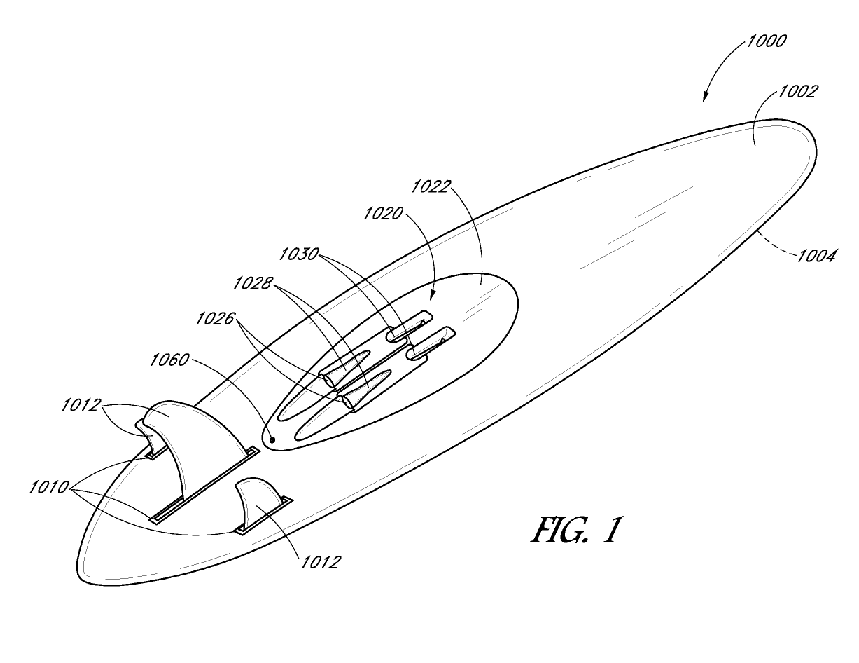

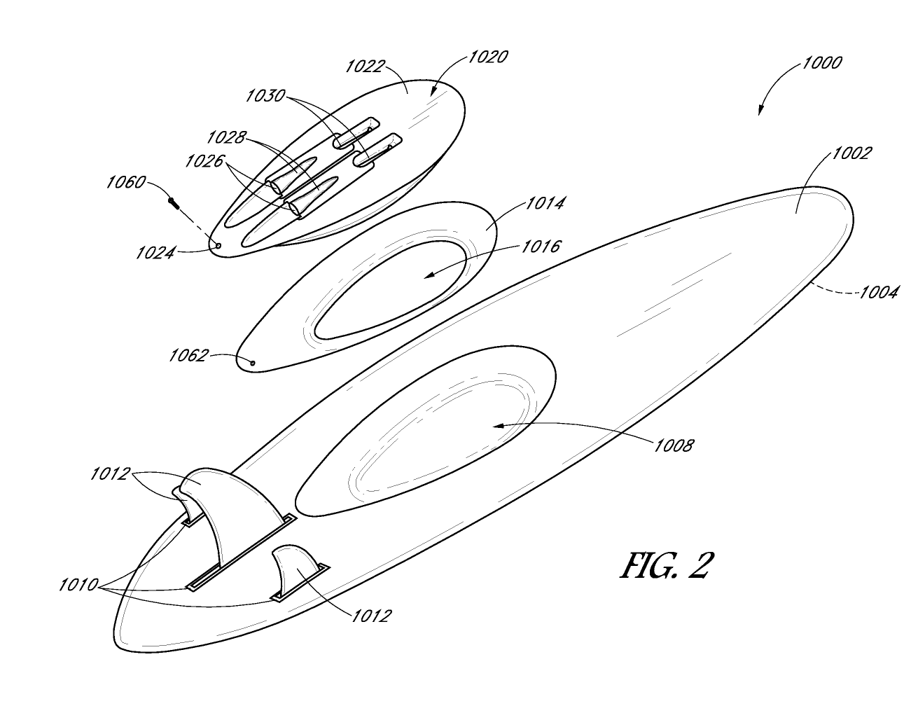

FIGS. 1 and 2 illustrate a personal watercraft comprising a first embodiment of a motorized cassette 1020 and a surfboard body 1000 is shown. The body 1000 comprises a top side 1004 and a bottom side 1002. In other embodiments, the body 1000 may comprise other traditionally non-powered watercrafts including, for example, inflatable watercrafts, dinghies, life rafts, tenders, sail boards, stand up paddle boards (“SUP boards”), kayaks, and canoes. The body 1000 may be constructed by affixing a top shell to a bottom shell or may be constructed using other various methods known to those having ordinary skill in the art. The body 1000 may optionally comprise one or more fin boxes 1010 configured to receive one or more fins 1012.

Turning now to FIG. 2, the bottom side 1002 of the body 1000 may comprise a recess 1008 configured to receive a cassette 1020 therein. The recess 1008 may extend from the bottom surface 1002 toward the top surface 1004 and comprise a generally convex shaped depression in the bottom surface 1002 of the body 1000. In one embodiment, the recess 1008 forms a tear-drop shaped aperture in the bottom surface 1002. The tear-drop shaped aperture may be complimentary to the shapes of an insert 1014 and/or cassette 1020 such that the insert 1014 and/or cassette 1020 can be oriented and/or positioned in a desired configuration within the recess 1008. As explained in further detail below, the insert can be useful because it can include desired features such as flanges, threaded holes for fastener engagement, and the like that can be used to, among other things, secure the cassette in the recess of the surfboard. This allows the shell of the surfboard itself to be entirely made with smooth and gently rounded surfaces in and around the recess 1008 and without sharp corners, holes, or other features that require difficult manufacturing processes. This makes the production of the surfboard 1000 itself very easy and requires minimal changes to the process of manufacturing a conventional surfboard.

With continued reference to FIG. 2, the insert 1014 may comprise a solid or substantially ring-shaped sheet structure configured to cover at least a portion of the recess 1008. The insert 1014 may be coupled to the recess 1008 using various coupling means, for example, adhesives, bonding agents, and/or fasteners. In some embodiments, by virtue of the complimentary shapes of the insert 1014 and the recess 1008, the insert 1014 may be form fitted within the recess 1008 such that the engagement therebetween inhibits longitudinal, lateral, and/or transverse motion of the insert 1014 relative to the recess 1008. When disposed within the recess 1008, the insert 1014 can define a receiving space 1016 for receiving the cassette 1020. In some embodiments, the insert 1014 may comprise one or more relatively small flanges or protrusions (not shown) extending into the receiving space 1016. The one or more flanges can be configured to engage one or more mating grooves (not shown) disposed in the cassette 1020. In one embodiment, a flange extends from a forward most portion of the insert 1014 into the receiving space 1016 and the forward most portion of the cassette 1020 includes a corresponding groove. In this way, the cassette 1020 may releasably engage the insert 1014 to align and hold the front of the cassette 1020 relative to the insert 1014 and body 1000. As shown in FIG. 1, the base surface 1022 of the cassette 1020 may be configured to substantially match the adjacent base surface 1002 of the body 1000 to achieve a desired hydrodynamic profile of the personal watercraft.

The cassette 1020 may be releasably coupled to the insert 1014 and recess 1008 by one or more fasteners 1060. In one embodiment, the insert 1014 includes an internally threaded bore 1062 configured to threadably engage a portion of a threaded fastener 1060, for example, a screw, that passes through a corresponding aperture 1024 formed in the cassette 1020. In another embodiment, a threaded bore is disposed in the body 1000 and configured to engage a portion of threaded fastener 1060. In one embodiment, a groove on a first end of the cassette 1020 may releasably receive at least a portion of a corresponding flange extending from the insert 1014 and the second end of the cassette 1020 may be fastened to the insert/body by fastener 1060 to restrict longitudinal, lateral, and/or transverse motion of the cassette 1020 relative to the recess 1008. As discussed in more detail below, the receiving space 1016 may be configured to releasably receive various different cassettes that are similarly shaped to cassette 1020.

As shown in FIGS. 1 and 2, the removable cassette 1020 may comprise a drive system for the personal watercraft. In one embodiment, the drive system components are housed within the cassette 1020. For example, the cassette 1020 may comprise one or more exhaust ports 1026, one or more pump housings 1028, one or more motor shafts 1030, one or more motors (not shown), one or more batteries (not shown), and/or one or more impellers (not shown). Thus, cassette 1020 may propel the body 1000 relative to a body of water, for example, to aid in paddling out a surfboard and catching waves.

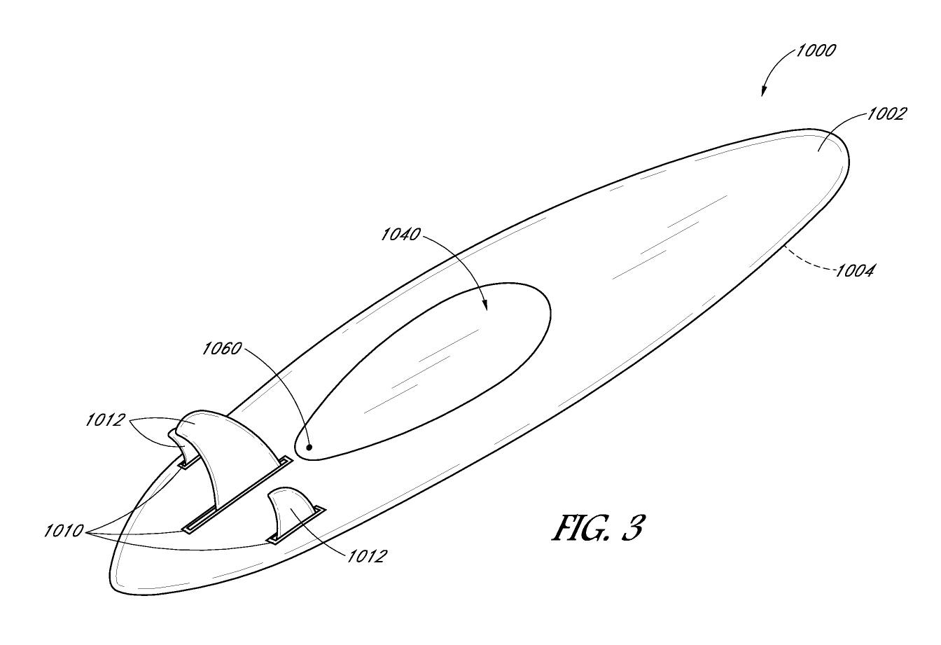

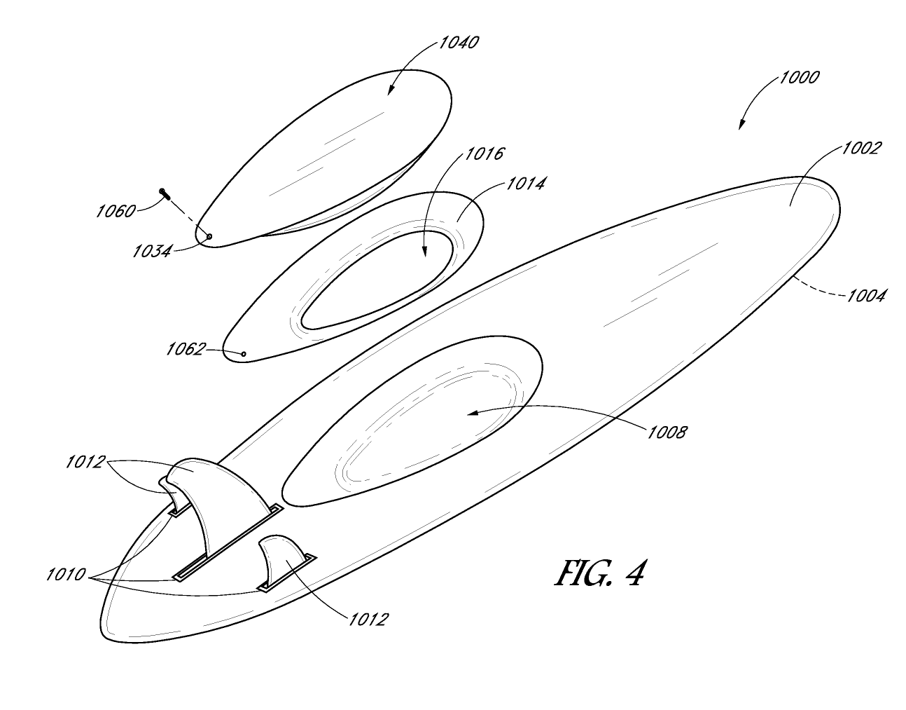

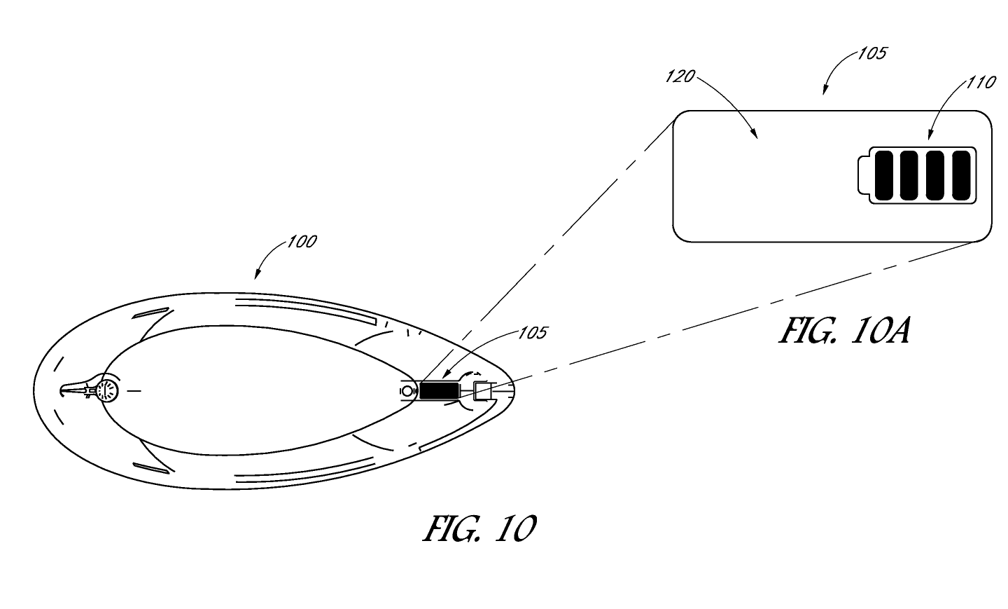

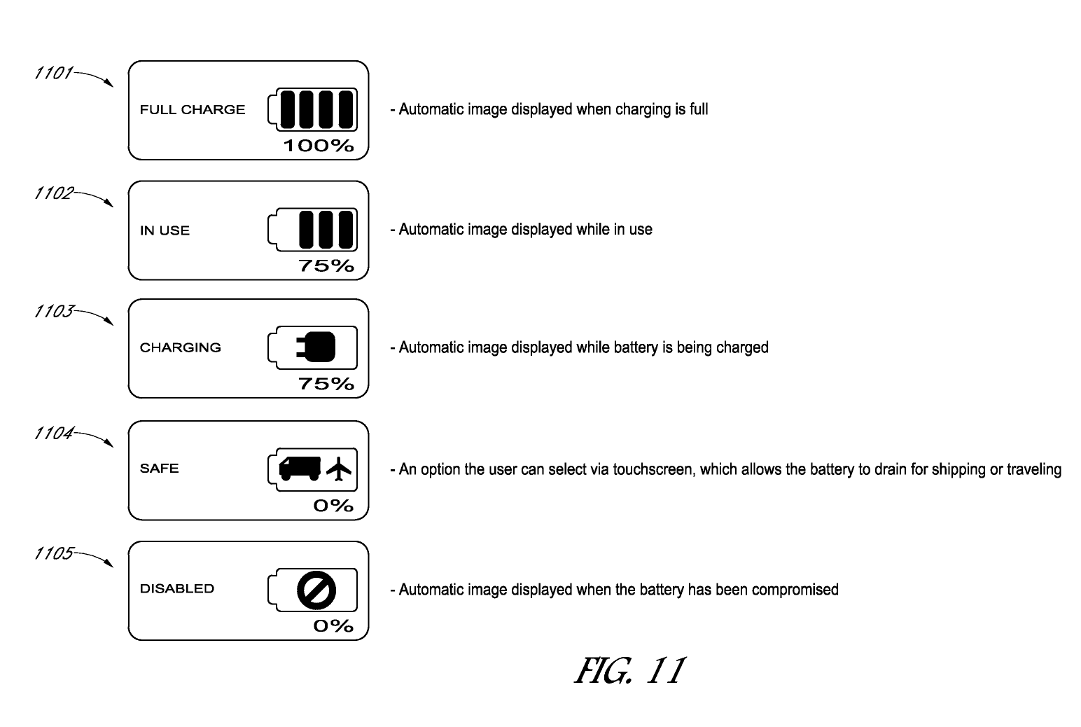

FIGS. 3 and 4 show the personal watercraft comprising a second embodiment of a cassette 1040 received within body 1000. Cassette 1040 may be similarly shaped to cassette 1020 of FIGS. 10 and 11 such that both cassettes fit tightly within the receiving space 1016 formed by insert 1014. Cassette 1040 may be releasably coupled to the body 1000 by one or more threaded fasteners 1060 and/or the engagement between a flange extending from the insert and a groove in the cassette 1040. As shown, fastener 1060 may pass through an aperture 1034 in the cassette 1040 and be received within threaded bore 1062 in insert 1014.

In contrast to cassette 1020 of FIGS. 1 and 2, cassette 1040 may be un-powered or non-motorized. In some embodiments, the cassette 1040 may be hollow and may enclose a storage space configured to store personal items, for example, sun screen, watercraft hardware, keys, mobile phones, etc. In one embodiment, the storage space may be substantially water tight to protect items stored therein from the ingress of water from a body of water, for example, the ocean. In other embodiments, the cassette 1040 may be substantially solid such that the watercraft has generally uniform buoyancy and/or rigidity characteristics from the front end to the back end.

The cassette 1020 of FIGS. 1 and 2 and the cassette 1040 of FIGS. 3 and 4 may be interchanged to convert the body 1000 between a motorized configuration (FIGS. 1 and 2) and a non-motorized configuration (FIGS. 3 and 4). The body 1000 may come as a kit with one or both of the motorized cassette 1020 and the non-motorized cassette 1040. A user may switch between cassettes 1020 and 1040 depending on water conditions and/or desired performance characteristics of the personal watercraft. For example, a user may wish to lower the overall mass characteristic of the personal watercraft by opting to place the non-motorized cassette 1040 within the body 1000 or a user may wish to minimize human energy used in a surf session by opting to place the motorized cassette 1020 within the body 1000.

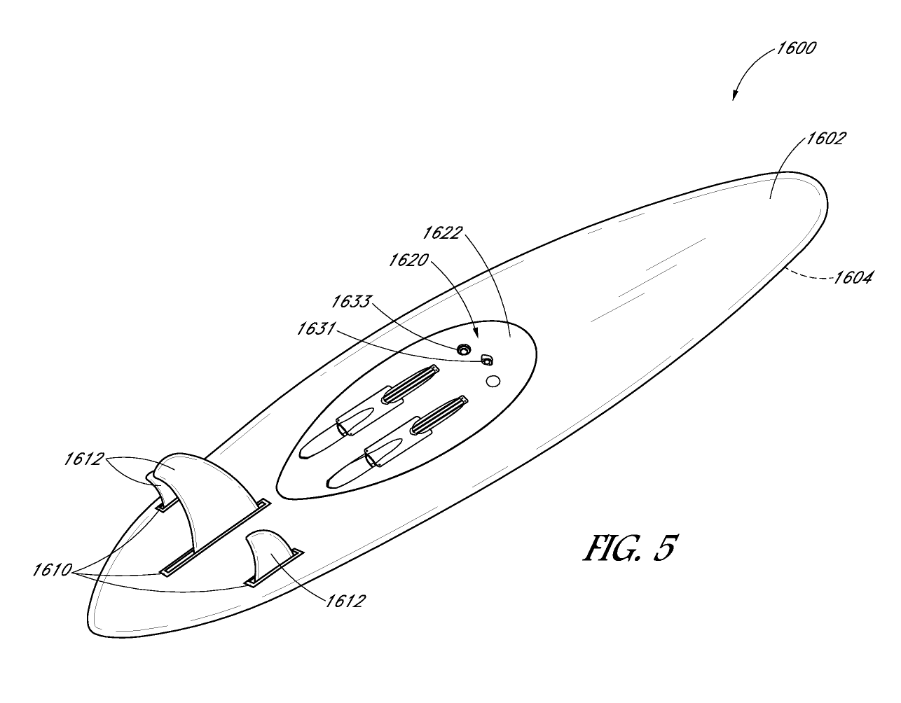

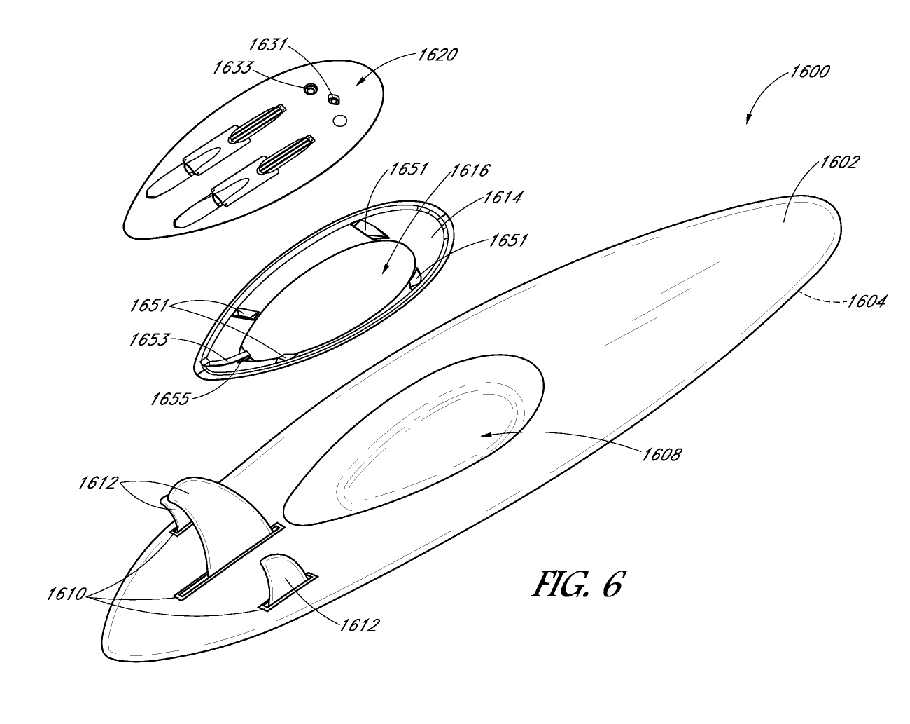

Turning now to FIGS. 5 and 6, a personal watercraft comprising a motorized cassette 1620 and a watercraft body 1600 is shown. The body 1600 comprises a top side 1604 and a bottom side 1602. In some embodiments, the body 1600 may comprise a surfboard and in other embodiments the body 1600 may comprise other various watercrafts. Similar to the personal watercraft of FIGS. 1-4, the body 1600 may be constructed by affixing a top shell to a bottom shell as discussed above or may be constructed using other various methods known to those having ordinary skill in the art. The body 1600 may optionally comprise one or more fin boxes 1610 configured to receive one or more fins 1612.

Turning now to FIG. 6, the bottom side 1602 of the body 1600 may comprise a recess 1608 configured to receive a cassette 1620 therein. The recess 1608 may extend from the bottom surface 1602 toward the top surface 1604 and comprise a generally convex shaped depression in the bottom surface 1602 of the body 1600. In one embodiment, the recess 1608 forms a tear-drop shaped aperture in the bottom surface 1602. The tear-drop shaped aperture may be complimentary to the shapes of the insert 1614 and/or cassette 1620 such that the insert 1614 and/or cassette 1620 can be oriented and/or positioned in a desired configuration within the recess 1608.

With continued reference to FIG. 6, the insert 1614 may comprise a solid or substantially ring-shaped sheet structure configured to cover at least a portion of the recess 1608. The insert 1614 may be coupled to the recess 1608 using various coupling means, for example, adhesives, bonding agents, and/or fasteners. In some embodiments, by virtue of the complimentary shapes of the insert 1614 and the recess 1608, the insert 1614 may be form fitted within the recess 1608 such that the engagement therebetween inhibits longitudinal, lateral, and/or transverse motion of the insert 1614 relative to the recess 1608. When disposed within the recess 1608, the insert 1614 can define a receiving space 1616 for receiving the cassette 1620.

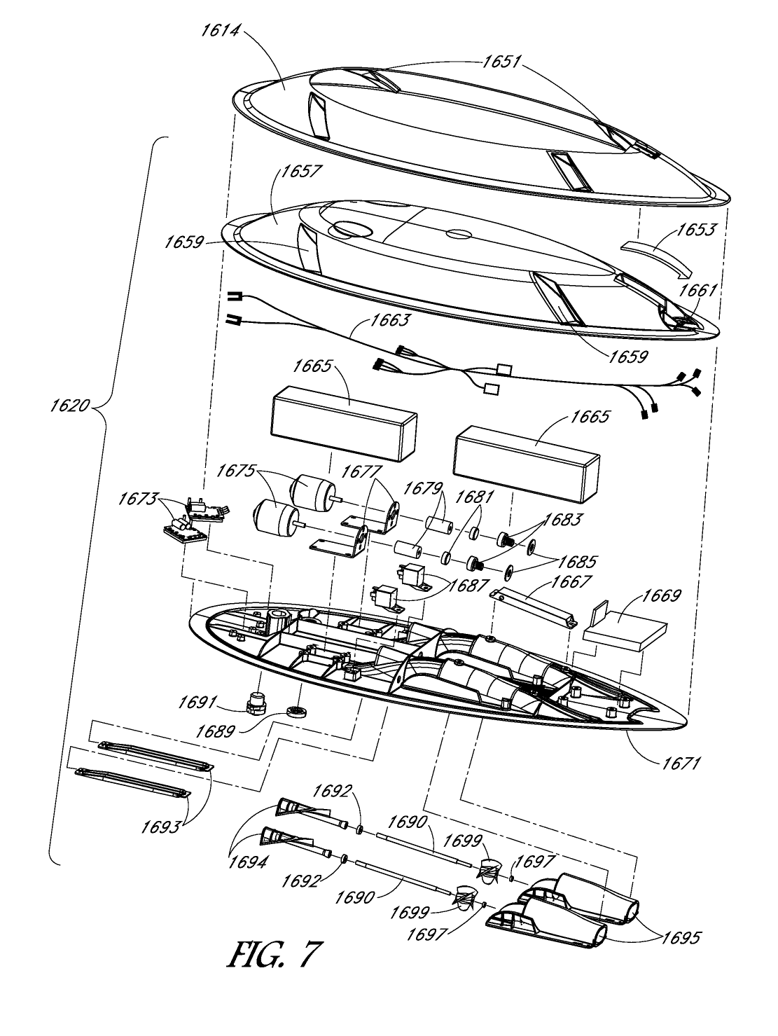

In some embodiments, the insert 1614 may include one or more protrusions 1651 configured to be inserted into one or more indentations 1659 (shown in FIG. 7) on the cassette 1620. The protrusions 1651 and indentations 1659 on the cassette 1620 can have complimentary shapes such that the protrusions may be received by the indentations by sliding the cassette 1620 forward longitudinally relative to the insert 1614. The engagement of the protrusions 1651 and corresponding indentations can result in one or more abutments that act to arrest or inhibit longitudinal, lateral, and/or transverse movement of the cassette 1620 relative to the insert 1614 and body 1600.

The insert 1614 may also include a latch element 1653 that is cantilevered from a latch plate 1655. The latch element 1653 may catch one or more surfaces within a receptacle 1661 (shown in FIG. 7) on the cassette 1620 when the cassette 1620 is received within the insert 1614 to secure the cassette 1620 in the longitudinal direction relative to the insert 1614. In this way, the cassette 1620 may be slid forward into the insert 1614 until the latch 1653 releasably engages a notch or other feature on the cassette such that the cassette 1620 is aligned and secured relative to the insert 1614. To remove the cassette 1620 from the insert 1614, the latch element 1653 may be depressed by applying a force to the cantilevered end of the latch element 1653 to disengage the latch element from the notch or other feature of the cassette. Disengaging the latch element 1653 then will allow a user to slide the cassette 1620 backward longitudinally relative to the insert 1614 to release the protrusions 1651 from the indentations 1659 and to remove the cassette 1620 from the body 1600.

As shown in FIG. 5, the base surface 1622 of the cassette 1620 may be configured to substantially match the adjacent base surface 1602 of the body 1600 to achieve a desired hydrodynamic profile of the personal watercraft. The base surface 1622 may also include a charging port 1631 and/or activation switch 1633. Thus, the cassette 1620 may be charged when the cassette is coupled to the watercraft body 1600 or when it is separate from the watercraft body. In embodiments when these are provided, the charger port 1631 can be disposed on an opposite side of the cassette 1620 and the activation switch 1633 can be disposed elsewhere as well if desired.

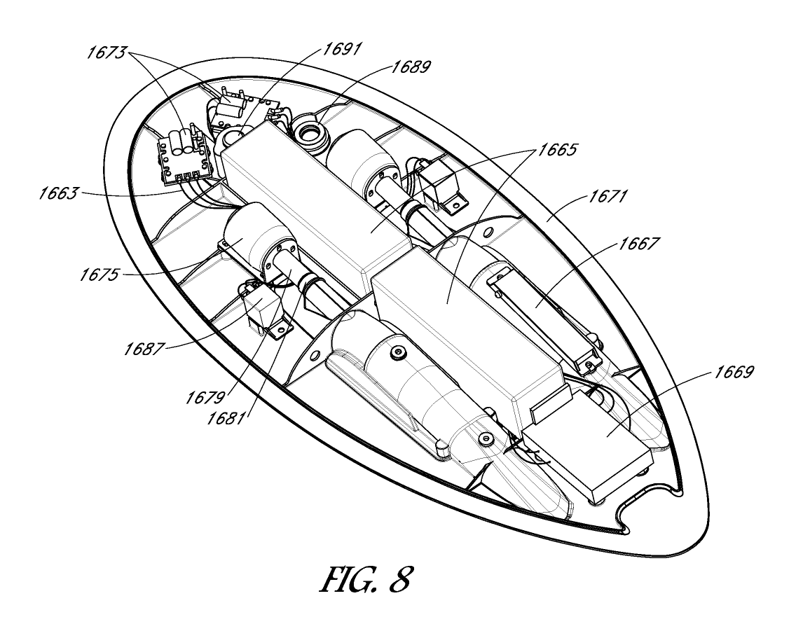

As shown in FIGS. 7 and 8, the removable cassette 1620 may comprise a drive system including one or more motors 1675. In one embodiment, the drive system can be at least partially housed between a cassette base 1671 and a cassette cover 1657. The one or more motors 1675 can be powered by one or more batteries 1665 and can be mounted to the cassette base 1671 by motor mounts 1677. In some embodiments, each motor 1675 can be coupled to a motor shaft 1690 by a shaft coupler 1679, shaft bearing 1681, bearing holder 1683, and spacer 1685. Each shaft 1690 can be coupled to an impeller 1699 that is disposed at least partially within a pump housing 1695 and a bearing 1697 can optionally be disposed between each shaft and the impeller 1699. In this way, the one or more motors 1675 can drive each impeller 1699 to draw water through the pump housing 1695 to propel the cassette relative to a body of water. The interior of the cassette 1620 may comprise a hermetically sealed environment. In some embodiments, the cassette base 1671 and cassette cover 1657 are sealed together with vibrational welding. In this way, a waterproof seal is formed between the cassette base 1671 and cassette cover 1657.

In some embodiments, each shaft 1690 can be disposed within a shaft housing 1694 that is configured to limit the exposure of the shaft 1690 to objects that are separate from the cassette 1620. Thus, the shaft housing 1694 can protect a user from inadvertently contacting the shaft 1690 during use and/or can protect the shaft 1690 from contacting other objects, for example, sea grass. Additionally, the shaft housing 1694 can improve performance of the cassette 1620 by isolating each shaft 1690 from the water that passes through the pump housing 1695. In some embodiments, each shaft 1690 can be protected from exposure to the water by one or more shaft seals 1692.

The cassette 1620 can also include one or more grates 1693 disposed over intake ports of the pump housing 1695. The grates 1693 can limit access to the impeller 1699 and shaft 1690 to protect these components and/or to prevent a user from inadvertently contacting these components during use. In some embodiments, each pump housing 1695 and/or grate 1693 can be coupled to one or more magnetic switches (not shown) that can deactivate the motors 1675 when the pump housing 1695 and/or grate 1693 are separated from the cassette base 1671. Therefore, the one or more magnetic switches may prevent the cassette from operating without the optional grate 1693 and/or pump housing in place.

With continued reference to FIGS. 7 and 8, the drive system may also include one or more motor controllers 1673 for each motor 1675, one or more relays 1687 configured to connect the one or more batteries 1665 with the one or more motor controllers 1673, an antenna 1667, and a transceiver 1669. The one or more motor controllers 1673, one or more relays 1687, one or more batteries 1665, antenna 1667, an transceiver 1669, can be electrically connected to each another by one or more wiring harnesses 1663. As discussed above, the transceiver 1669 can include or be coupled to wireless transmission circuitry that is configured to transmit electromagnetic and/or magnetic signals underwater.

In one embodiment, a motorized cassette described above, includes a plurality of environmental sensors located in a plurality of locations within the cassette. If one of the plurality of sensors detects a harmful condition, water within the cassette for example, the batteries within the cassette are effectively disconnected from the motors and are slowly discharged. A display located on the exterior of the cassette can alert the user that the sensors detected a harmful condition and that the device is being discharged. The display can also notify the user when the batteries have been drained.

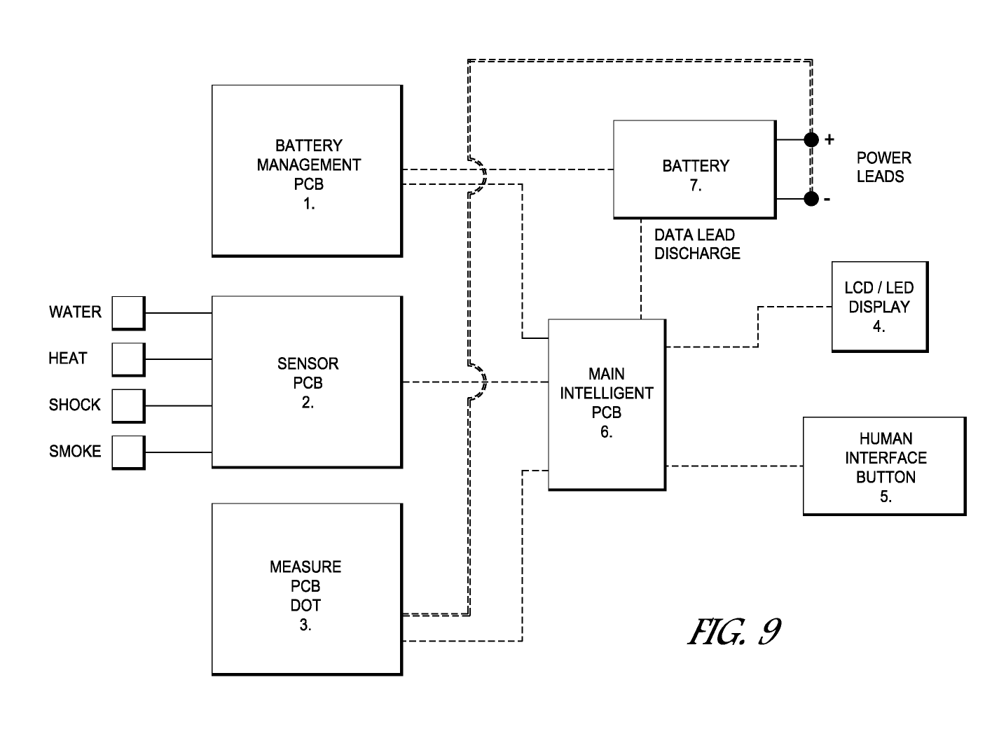

FIG. 9 illustrates a block diagram of a battery management system for a motorized cassette according to one embodiment. As shown, the battery management system can include a battery management module 1, a sensor module 2, a measurement interface 3, a display 4, an input 5, a main intelligent module 6, and a battery 7.

The battery management module 1 can function as a protector and/or battery cell management device and can be coupled to one or more batteries 7 as well as the main intelligent module 6. The battery management module 1 can regulate and ensure balanced cell voltages. The battery management module 1 can also control battery charging and discharging.

The sensor module 2 can be coupled to the main intelligent module 6 and can detect one or more internal environmental conditions of the cassette such as, for example, water, heat, shock, or smoke. The sensor module 2 may also, or in the alternative, detect the physical battery condition, for example battery size, and/or the electronic characteristics of the battery. In one embodiment, if sensor module 2 detects water within the cassette, the sensor module 2 sends a signal to the main intelligent module 6. The main intelligent module 6 can then disable the one or more batteries (by blowing an output fuse leading from the battery output for example) and/or trigger a slow discharge of the batteries.

The measurement interface 3 can be coupled to the battery 7 and/or the main intelligent module 6. The measurement interface 3 can be compatible with testing equipment approved by an agency such as the Department of Transportation or the Federal Aviation Administration. In this way, the measurement interface 3 can function as a connection point for third party testing equipment in order measure the battery charge status and/or verify that the battery 7 is discharged. For example, a user of a watercraft configured to house a motorized cassette may wish to travel in an aircraft. The user can remove the cassette from the watercraft and manually initiate the battery discharge. The user can then present the cassette for inspection by, for example, a dangerous goods inspector. The dangerous goods inspector can use standard testing equipment to connect to the measurement interface 3 and verify that the batteries in the cassette are discharged. The cassette can then be approved for travel on the aircraft.

Continuing with FIG. 9, the display 4 can be coupled to the main intelligent module 6 and can visually display the status of battery. For example, the display 4 can display the battery charge level and/or status of the batteries 7. The display 4 may be an LCD or LED display. The display 4 may include a touch screen or other user interface.

The input 5 can be coupled to the main intelligent module 6 and can be used to initiate the discharging of the batteries 7. For example, in one embodiment, the input 5 comprises a button that, when depressed, signals the main intelligent module 6 to initiate discharging of the batteries 7.

The main intelligent module 6 can monitor the battery management module 1, the sensor module 2, and the battery 7. The main intelligent module 6 can send data to the display 4 and can receive input from the input 5. The battery 7 may include one or more batteries. The batteries 7 may be lithium or lithium ion batteries. The main intelligent module 6 can compare a sensor output to a threshold level and may disconnect and/or discharge a battery if the sensor output exceeds the threshold level.

FIG. 10 is a top view of a motorized cassette 100 having a user interface 105 for a battery management system according to one embodiment. As shown, the interface 105 includes a display. The display may be an LCD or LED display. The interface 105 may further include one or more buttons and/or may include a touch screen portion 120. The display may display one or more icons 110. The display can allow for a person to easily obtain the charge status of the batteries in the cassette. In some embodiments, the display can alert a user of the status of the batteries. For example, the display can indicate if the cassette is safe to travel with, if the cassette is charging properly, and/or if the cassette is ready for inspection approval by government agencies or shipping companies.

FIG. 11 illustrates sample outputs 1101-1105 of the display. In one embodiment, the user interface 105 is a LCD touchscreen interface. The LCD touchscreen interface can allow for a user to cycle through various options available. For example, the LCD touchscreen interface may allow for a user to manually activate the discharging of the batteries.

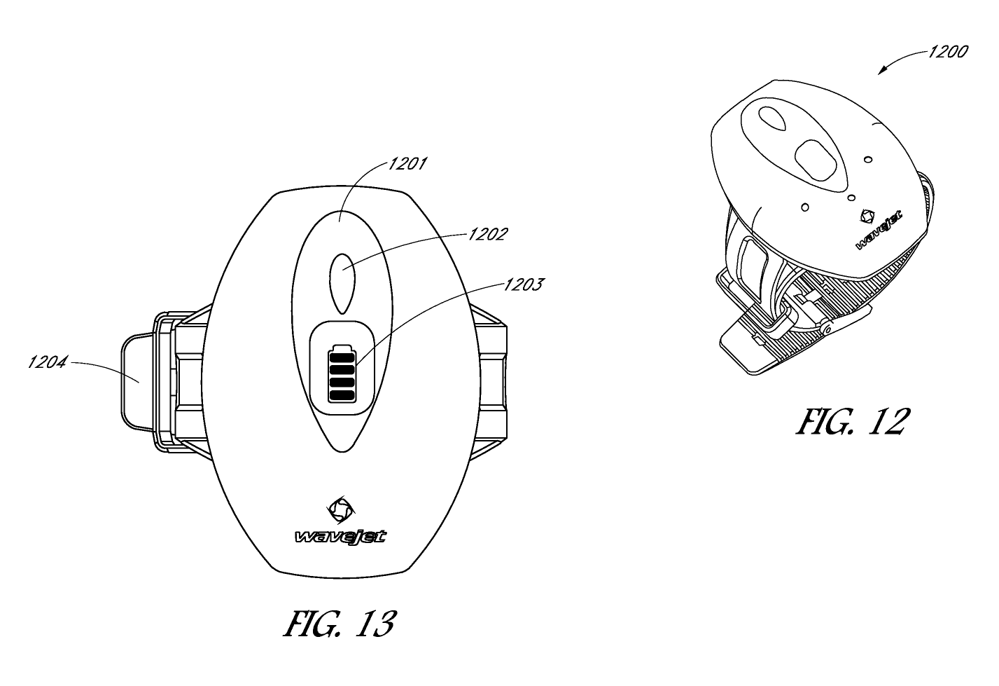

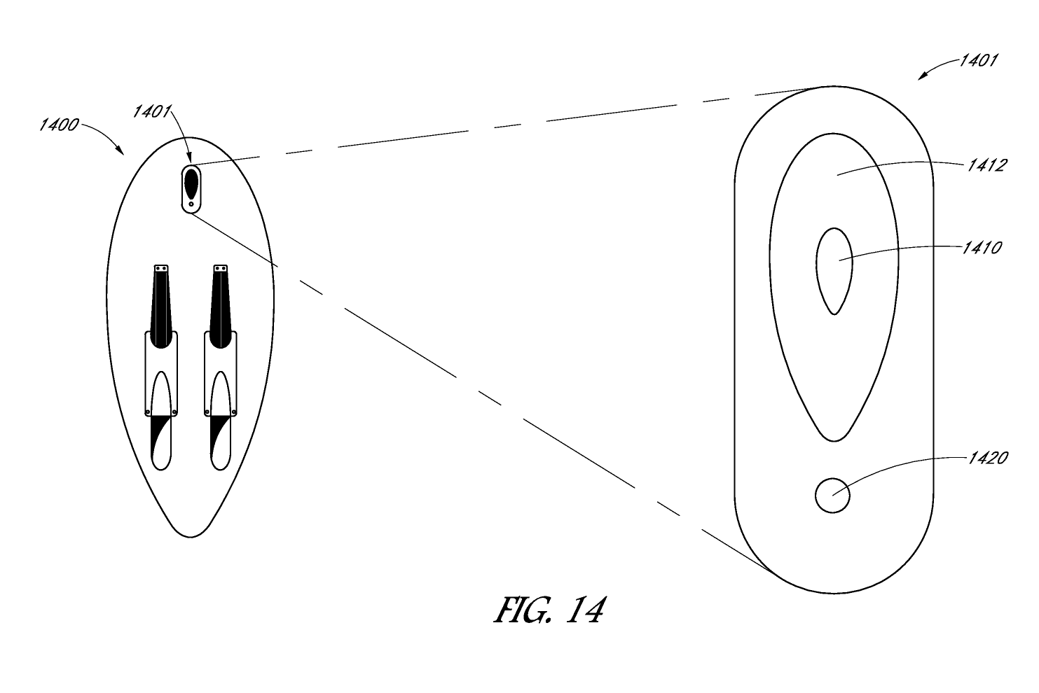

Turning to FIGS. 12 and 13, a wireless wrist controller 1200 may be configured to operate and/or control the cassette. For example, the wrist controller 1200 can be configured to turn the motors on and off. The wrist controller 1200 can include a wrist strap 1204, a rubber overmold 1201, an input 1202, and a display 1203. The wrist controller 1200 can be configured to operate when submerged in water for prolonged periods of time. The display 1203 can allow for a person to wirelessly obtain the charge status of the batteries in the cassette. In some embodiments, the display 1203 can alert a user of the status of the batteries. For example, the display 1203 can indicate if the cassette is safe to travel with, if the cassette is charging properly, and/or if the cassette is ready for inspection approval by government agencies and/or shipping companies. FIG. 11 illustrates sample outputs 1101-1105 of the display 1203. In some embodiments, the display 1203 further includes a touch screen. The input 1202 can comprise a button or switch. As shown, the input 1202 comprises a toggle button. In some embodiments, the toggle button is used to turn the motors of the cassette on or off.

In some embodiments, the wireless wrist controller 1200 can independently verify the battery status and/or charge level. In other words, the wireless wrist controller 1200 can include testing equipment approved by an agency such as the Department of Transportation or the Federal Aviation Administration. In this way, the wireless wrist controller 1200 can verify that the status of the batteries within the cassette. This separate and independent verification step can further ensure that the batteries within the cassette are fully discharged.

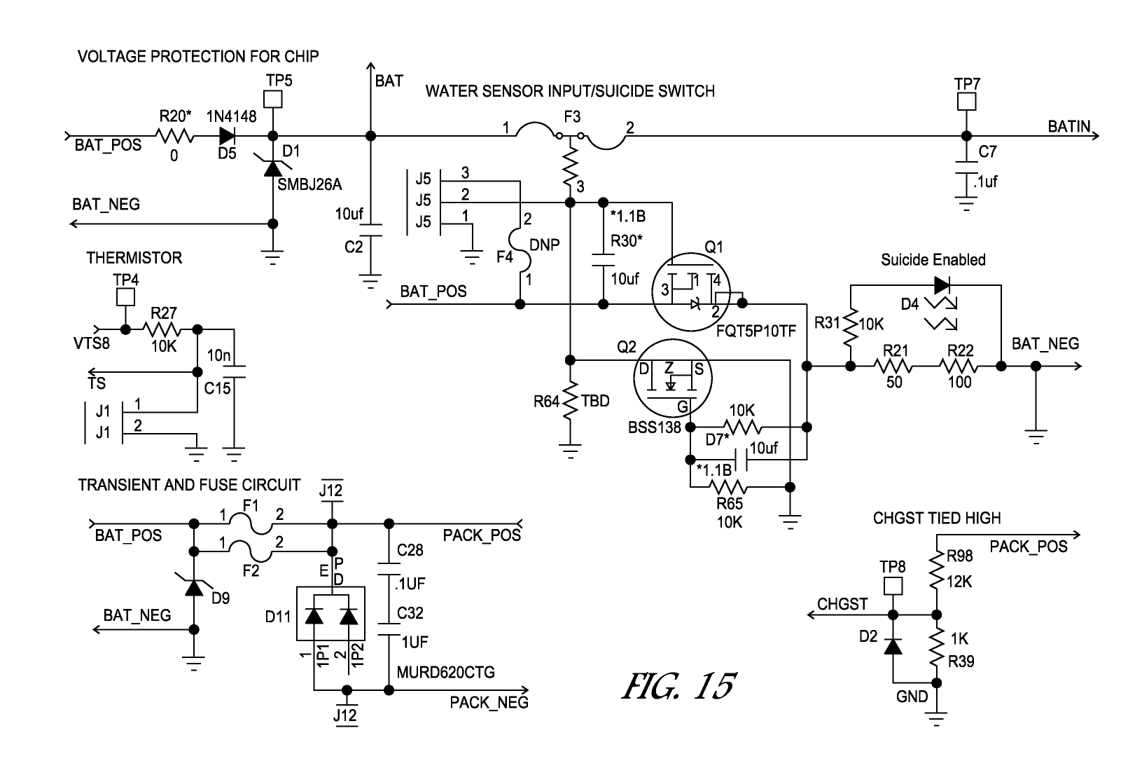

FIG. 14 is a top view of a motorized cassette 1400 having a user interface for a battery management system according to according to another embodiment. As shown, the motorized cassette 1400 includes an interface 1401. The interface 1401 includes a light 1420 and a button 1410 surrounded by a rubber protector 1412. The button 1410 can allow a user to toggle between various modes such as on, off, manual discharge, or emergency discharge. The light 1420 can indicate the status of the battery within the cassette 1400. In one embodiment, the light 1420 is off when the cassette 1400 batteries are fully discharged. In one embodiment, the light is on when the batteries have a charge. In one embodiment, the light 1420 flashes when the battery is being discharged. The light may flash more often or in a different color if the emergency discharge was activated. The emergency discharge may occur when one or more internal sensors detect a dangerous internal condition within the cassette such as excess heat, water, smoke, or a large shock.

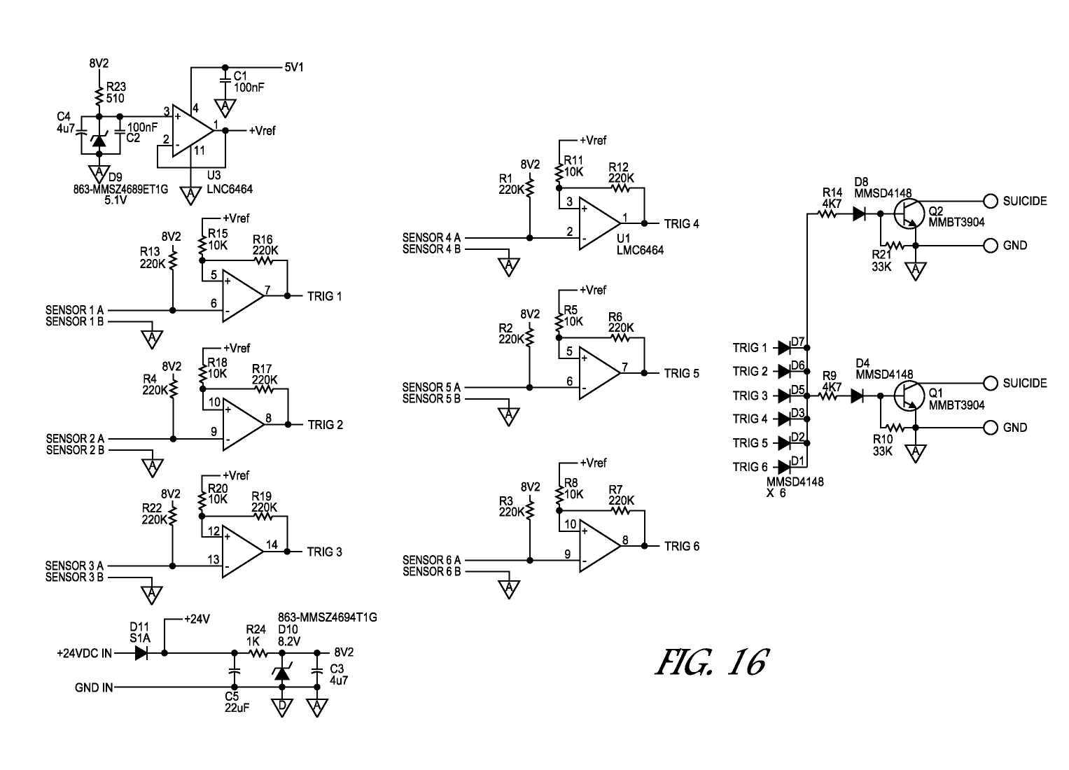

FIGS. 15 and 16 illustrate one implementation of a schematic for battery protection that may be implemented in the cassette illustrated above. The battery output includes a fuse F3 (FIG. 15). Multiple water sensors, which may be adjacent traces on printed circuit boards that are positioned in several locations within the cassette, that become conductively connected in the presence of water, are each connected to amplifiers (FIG. 16) that have outputs that go high when water is present. When one of these triggers goes high, pin 2 of connector J5 is pulled low, turning on Q1 (FIG. 15). This blows fuse F3 and discharges the batteries slowly through discharge resistors R21 and R22 (FIG. 15). Q2 (FIG. 15) will hold the gate of Q1 low even if pin 2 of J5 is released from ground. LED D4 (FIG. 15) will become lit up during this process, which may be visible to a user on the outside of the cassette, informing the user that the battery protection procedure is in process.

The above description is provided to enable any person skilled in the art to make or use embodiments within the scope of the disclosed inventions. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A battery protection system comprising:
one or more batteries;
one or more sensors configured to detect at least one environmental condition external to the battery; and
a circuit coupled to the one or more sensors configured to discharge the one or more batteries based at least in part on sensor detection of the at least one environmental condition external to the battery.

2. (canceled)

3. The system of claim 1, wherein the one or more batteries, the one or more sensors, and the circuit are housed within an enclosure.

4. (canceled)

5. The system of claim 1, wherein the at least one environmental condition is an environmental condition not caused by the one or more batteries.

6. The system of claim 5, comprising at least one sensor configured to detect water.

7. The system of claim 6, wherein at least one sensor configured to detect water comprises adjacent traces on a printed circuit board that are conductively connected in the presence of water.

8. The system of claim 5, comprising at least one sensor configured to detect mechanical shock.

9. The system of claim 1, comprising at least one sensor configured to detect smoke.

10. The system of claim 1, comprising at least one sensor configured to detect temperature.

11. The system of claim 1, comprising at least one sensor configured to detect mechanical stress.

12. The system of claim 1, comprising at least two sensors configured to detect two or more of water, smoke, temperature, mechanical stress, and mechanical shock.

13-41. (canceled)

42. A battery protection method comprising:
detecting at least one environmental condition external to a battery; and
discharging the battery based at least in part on detection of the at least one environmental condition external to the battery.

43. The method of claim 42, comprising detecting an environmental condition not caused by the battery.

44. The method of claim 43, comprising detecting water.

45. The method of claim 43, comprising detecting mechanical shock.

46. The method of claim 42, comprising detecting smoke.

47. The method of claim 42, comprising detecting temperature.

48. The method of claim 42, comprising detecting mechanical stress.

49. The method of claim 42, comprising detecting two or more of water, smoke, temperature, mechanical stress, and mechanical shock.

50. The system of claim 1, comprising at least one sensor configured to detect an increase in physical size of the one or more batteries.

51. The system of claim 1, wherein the one or more batteries, the one or more sensors, and the circuit are installed in a personal watercraft.
